(19) United States
(12) Patent Application Publication
(10) Pub. No.: US 2016/0122598 A1
(43) Pub. Date: May 5, 2016

(54) CROSSLINKABLE ADHESIVE COMPOSITION

(71) Applicant: Saint-Gobain Performance Plastics Corporation, Aurora, OH (US)

(72) Inventors: Xiaonan ZHU, Shanghai (CN); Yue DONG, Shanghai (CN)

(21) Appl. No.: 14/928,522

(22) Filed: Oct. 30, 2015

(30) Foreign Application Priority Data
Oct. 31, 2014 (CN) 201410602699.9

(51) Int. Cl. C09J 133/08

(52) U.S. Cl. CPC C09J 133/08; C08K 3/36

(57) ABSTRACT

Embodiments of the present disclosure relate to adhesive compositions containing an adhesive resin and a crosslinkable component. The novel compositions can exhibit synergistic improvements in parameters such as modulus, overlap shear strength, shelf life, and others.

### CROSS-REFERENCE TO RELATED APPLICATION(S)

This application claims priority to Chinese Application No. 201410602699.9, filed Oct. 31, 2014, entitled, “CROSSLINKABLE ADHESIVE COMPOSITION,” by Zhu et al. Each patent application cited herein is hereby incorporated by reference in its entirety.

### FIELD OF THE DISCLOSURE

The present disclosure relates to adhesive compositions, and more particularly to crosslinkable adhesive compositions.

### RELATED ART

Adhesive compositions, and particularly structural adhesive compositions are used in a wide range of applications, and can be particularly useful when strong overlap shear strength over an extended period of time, in the order of years, is desired. For example, an adhesive composition that can be used as a bonding tape for adhering automotive parts such as rear view mirrors and rain sensors to windshields.

The current solutions in the marketplace all have drawbacks. For example, the structural adhesive and structural bonding tape produced by 3M and identified as 3M™ Automotive Structural Bonding Tape 9214 and 9270 are two examples. These tapes are formulated for bonding of rear view mirror buttons to automotive windshield glass, and are applied as a pressure-sensitive tape, and then heat-cured to develop structural strength. These tapes offer good overlap shear strength, but suffer in low shelf life and exhibit high modulus at low temperatures, limiting the ability to use the bonding tape in cold weather.

Embodiments of the present disclosure overcome these drawbacks and can further provide additional advantages including a synergistic improvement between overlap shear strength, shelf life, and modulus as will be described in detail below.

### BRIEF DESCRIPTION OF THE DRAWINGS

Embodiments are illustrated by way of example and are not limited in the accompanying figures.

FIG. 1 includes a graph of the modulus across the temperature range tested in Example 1.

FIG. 2 includes a graph representing the results of the rheology shelf life tested in Example 2b.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single item is described herein, more than one item may be used in place of a single item. Similarly, where more than one item is described herein, a single item may be substituted for that more than one item.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the adhesive arts.

The present disclosure is generally directed to curable adhesive compositions, such as compositions containing an adhesive resin and a crosslinkable component. Embodiments of the disclosure can exhibit improved synergistic benefits in parameters such as shelf life, application temperature range and conformability, and others. The concepts are better understood in view of the embodiments described below that illustrate and do not limit the scope of the present invention.

In certain embodiments, the curable adhesive composition can contain an adhesive resin.

In particular embodiments, the adhesive resin can include an acrylic resin. In very particular embodiments, the adhesive resin, such as an acrylic resin, can include a pressure sensitive adhesive (PSA) resin.

Particular examples of suitable pressure sensitive adhesive resins include, but are not limited to, adhesives based on general compositions of acrylate; polyvinyl ether; diene rubber such as natural rubber, polyisoprene, and polybutadiene; polyisobutylene; polychloroprene; butyl rubber; butadiene-acrylonitrile polymer; thermoplastic elastomer; block copolymers such as styrene-isoprene and styrene-isoprene-styrene (SIS) block copolymers, ethylene-propylene-diene polymers, and styrene-butadiene polymers; poly-alpha-olefin; amorphous polyolefin; silicone; ethylene-containing copolymer such as ethylene vinyl acetate, ethylacrylate, and ethyl methacrylate; polyurethane; polyamide; epoxy; polyvinylpyrrolidone and vinylpyrrolidone copolymers; polyesters; and mixtures or blends of the above.

In particular embodiments, the pressure sensitive adhesive resin can be based on general compositions of acrylates, such as poly(meth)acrylate, ethylacrylate, ethyl methacrylate, or combinations thereof. For example, the PSA acrylate can be a copolymer having monomers such as AA (acrylic acid), BA (n-butyl acrylate), CHMA (cyclohexyl methacrylate), IBA (isooctyl acrylate), IOA (isooctyl acrylate), MA (methyl acrylate), MAA (methacrylic acid), MMA (methyl methacrylate), EA (ethyl acrylate), and others.

In certain embodiments, the acrylate resin can contain an emulsion based acrylate PSA. In other embodiments, the acrylate resin can contain a solvent based acrylic PSA.

The pressure sensitive adhesive composition may contain additives including, but not limited to, tackifiers, plasticizers, fillers, antioxidants, stabilizers, pigments, diffusing materials, curatives, fibers, filaments, and solvents.

In certain embodiments, the adhesive resin can be present in the composition in an amount of at least 1 wt. %, at least 5 wt. %, at least 10 wt. %, at least 20 wt. %, at least 30 wt. %, at least 40 wt. %, at least 50 wt. %, or even at least 60 wt. %, based on the total dry weight of the composition. In further embodiments, the adhesive resin can be present in the composition in an amount of no greater than 90 wt. %, no greater than 85 wt. %, or even no greater than 80 wt. % based on the total dry weight of the composition. Moreover, in certain embodiments, the adhesive resin can be present in the composition in an amount in a range of any of the minimum and maximum values provided above, such as in a range of 1 wt. % to 90 wt. 5, or even 5 wt. % to 85 wt. %, based on the total dry weight of the composition.

As discussed above, the composition can comprise a first crosslinkable component. As used herein, the phrase “crosslinkable component” refers to a component which can form a crosslinked bond with another compound present in the composition, or with itself in an interpenetrated network (IPN), upon curing.

The first crosslinkable component can be in monomeric or polymeric form when combined with the acrylic resin. In particular embodiments, the crosslinkable component can be in monomeric form when combined with the acrylic resin.

In certain embodiments, the first crosslinkable component can form an interpenetrated network with itself upon curing. In other embodiments, the first crosslinkable component can form a crosslinked bond with another compound present in the composition. In still further embodiments, the first crosslinkable component can form either or both of a crosslinked bond with another compound present in the composition and form a interpenetrated network (IPN) upon curing.

In certain embodiments, the first crosslinkable component can be in the same phase as the acrylic resin described above. Put another way, in certain embodiments, the first crosslinkable component can not be in a separate phase from the acrylic resin. Put yet another way, in certain embodiments, the first crosslinkable component does not phase separate from the acrylic resin. As used herein the phrases “phase separate” or “not be in a separate phase” means that by differential scanning calorimetry (DSC) essentially no detectable thermal transition, such as a melting or glass transition temperature can be found for the pure crosslinkable component in the composition with acrylic resin. Some migration of the crosslinkable component from or throughout the composition can be tolerated, such as minor separation due to composition equilibrium or temperature influences, but the crosslinkable component does not migrate to the extent of phase separation between the acrylic resin and the crosslinkable component.

In certain embodiments, the first crosslinkable component can be non-volatile. For example, the first crosslinkable component can remain in the cured composition and will not substantially evaporate out of the composition during curing. A particular advantage of certain embodiments of the present disclosure is a non volatile first crosslinkable component, which can, in certain embodiments, also reduce the viscosity of the acrylic resin, depending of course on the particular type of acrylic resin employed and other components in the composition. Accordingly, in particular embodiments, the first crosslinkable component can provide a reduction in viscosity to the acrylic resin, and remain present and stable even under curing temperatures, and even maintain or improve the strength of the adhesive.

In particular embodiments, the first crosslinkable component can have at least one allyl group. In further embodiments, the first crosslinkable component can have at least two allyl groups.

In particular embodiments, the first crosslinkable component can contain a phthalate, such as a phthalate ester or an ester of phthalic acid.

In very particular embodiments, the first crosslinkable component can contain a diallyl phthalate polymer. In even further particular embodiments, the first crosslinkable component can contain diallyl orthophthalate.

In very particular embodiments, the first crosslinkable component can contain a compound according to formula (1) and/or formula (2):

CH2=CHCOOROOCCH═CH2 (1)

CH2=CHCH2OCOROCOCH2CH═CH2 (2)

wherein, R represents an aliphatic compound having from 1 to 12 carbon atoms, an ether group, an alicyclic hydrocarbon, or an aromatic hydrocarbon (having ortho-, iso-, or tere-structure).

In certain embodiments, the first crosslinkable component can be present in a significant, non additive amount. For example, traditional additives that are included in an adhesive composition are present in amounts of less than about 3 wt. %, based on the total weight of the adhesive composition. While, in the present disclosure, the first crosslinkable component can be present in a greater amount.

In particular embodiments, the first crosslinkable component can be present in the composition in an amount of at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 21 wt. %, at least about 22 wt. %, at least about 23 wt. %, at least about 24 wt. %, or even at least about 25 wt. %, based on the total weight of the composition.

In further embodiments, the first crosslinkable component can be present in the composition in an amount of no greater than about 75 wt. %, no greater than about 70 wt. %, no greater than about 65 wt. %, no greater than about 60 wt. %, no greater than about 55 wt. %, no greater than about 50 wt. %, no greater than about 45 wt. %, no greater than about 40 wt. %, or even no greater than about 35 wt. %, based on the total weight of the composition.

Moreover, in certain embodiments, the first crosslinkable component can be present in the composition in a range of any of the minimum and maximum amounts described above, such as in a range of 3 wt. % to 75 wt. %, 5 wt. % to 70 wt. %, 10 wt. % to 65 wt. %, or even 20 wt. % to 75 wt. %.

In certain embodiments, the composition can further include a second crosslinkable component, which is different than the first crosslinkable component. In particular embodiments, the second crosslinkable component can form a crosslinked bond with the acrylic resin. In other particular embodiments, the second crosslinkable component does not form an interpenetrated network (IPN). Furthermore, in certain embodiments, the second crosslinkable component can form a crosslinked bond with the first crosslinkable component.

In certain embodiments, the second crosslinkable component can be present in the composition in an amount of at least about 0.1 wt. %, at least about 0.2 wt. %, at least about 0.5 wt. %, at least about 0.8 wt. %, or even at least about 1 wt. %, based on the total weight of the composition.

In certain embodiments, the second crosslinkable component can be present in the composition in an amount of not greater than about 10 wt. %, not greater than about 8 wt. %, not greater than about 7 wt. %, not greater than about 5 wt. %, or not greater than about 3%, or not greater than about 1%, based on the total weight of the composition.

Moreover, in certain embodiments, the second crosslinkable component can be present in the composition in an amount in a range of any of the minimum and maximum values provided above, such as in a range of 0.1 wt. % to 10 wt. %, 0.5 wt. % to 8 wt. %, or even 1 wt. % to 5 wt. %.

In particular embodiments, the second crosslinkable component can be present in the composition in a weight percentage amount which is less than the weight percentage of first crosslinkable component, based on the total weight of the composition.

In particular embodiments, the second crosslinkable component can contain a structural adhesive resin. For example, in very particular embodiments, the second crosslinkable component can contain an epoxy, phenolic aldehyde, urea formaldehyde, alkyd resin, urethane, or combinations thereof. In particular embodiments, the second crosslinkable component can contain an epoxy.

In certain embodiments, the second crosslinkable component can begin or initiate crosslinking at a lower temperature than the first crosslinkable component, if both the first and the second crosslinking components are heat curable crosslinkable components. Put another way, the second crosslinkable component can have a cure temperature which is less than the first crosslinkable component.

In certain further embodiments, the second crosslinkable component can have a faster cure time than the first crosslinkable component. Cure time is a measure of the rate of formation of the crosslinked bonds during curing.

In certain embodiments, the composition can further include a heat resistant resin. The heat resistant resin can function to control the modulus of PSA resin to increase the heat resistance performance at high temperature (curing temperature), facilitate die-cut and other improvements.

In certain embodiments, classes of particular heat resistant resins can include elastomers. In particular embodiments, the elastomer can have a glass transition temperature of no greater than 100 degrees Celsius, no greater than 85 degrees Celsius, or even no greater than 70 degrees Celsius. In further embodiments, the elastomer can have a glass transition temperature of at least 0 degrees Celsius, at least 5 degrees Celsius, or even at least 10 degrees Celsius. Moreover, in particular embodiments, the elastomer can have a glass transition temperature in a range of any of the minimums and maximums provided above, such as in a range of from 10 degrees Celsius to 70 degrees Celsius.

In particular embodiments, the heat resistant resin can be based on acrylate, polyurethane (PU), a diallyl orthophthalate prepolymer, and others.

In certain embodiments, the heat resistant resin can not phase separate from the composition, as defined above.

In certain embodiments, the heat resistant resin can be present in the composition in an amount of at least about 1 wt. %, at least about 5 wt. %, or even at least about 10 wt. % based on the total dry weight of the composition. In further embodiments, the heat resistant resin can be present in the composition in an amount of no greater than 90 wt. %, no greater than 80 wt. %, or even no greater than 70 wt. % based on the total dry weight of the composition. Moreover, in certain embodiments, the heat resistant resin can be present in the composition in an amount in a range of any of the minimum and maximum values provided above, such as in a range of 1 wt. % to 90 wt. % based on the total weight of the composition.

In certain embodiments, the composition can further include a filler. The filler can function to increase the strength and hardness of the adhesive composition and control the viscosity, as compared to the same composition without the filler present.

In particular embodiments, suitable fillers can include silicon oxide, carbon black, hollow glass/ceramic beads, silica, titanium dioxide, solid glass/ceramic spheres, chalk or combinations thereof.

In certain embodiments, the filler can be present in the composition in an amount in a range of from about 0 to 10 wt. %, or even about 0.1 wt. % to about 5 wt. % based on the total dry weight of the composition.

The novel compositions disclosed in the present specification exhibit advantageous and synergistic physical and performance characteristics. For example, the novel compositions can contain an advantageous modulus, shelf-life, overlap shear strength, and others.

One characteristic of the novel compositions described herein is its modulus. The modulus is a measure of the composition's ability to function as an adhesive in different temperature climates. The modulus can be measured according to the Modulus Test, the procedure for which is as follows:

The composition is prepared and measured for modulus at different temperatures. An ARES-G2 Rheometer available from TA Instruments was used as the testing device. The testing device is set to oscillatory shear mode, temperature ramp is from −55 degrees Celsius to 150 degrees Celsius, with a temperature ramp rate of 5 degrees Celsius per minute and with an oscillatory frequency of a 1 Hz.

A particular advantage of embodiments the present disclosure is the low modulus of the composition that was able to be achieved, throughout a broad range of temperatures, and particularly low temperatures. As will be further illustrated in the Examples below, embodiments of the composition of the present disclosure exhibit a low modulus at low temperatures, and throughout a broad temperature range. Accordingly, adhesive articles formed with the composition can exhibit improved initial tack, particularly at low temperatures.

In certain embodiments, the composition can have a modulus of no greater than 10⁶ G′(Pa) at a temperature of 15 degrees Celsius, 10 degrees Celsius, 5 degrees Celsius, 0 degrees Celsius, −5 degrees Celsius, −10 degrees Celsius or even −50 degrees Celsius as measured according to The Modulus Test.

In further embodiments, the composition can have a modulus of no greater than 10⁶ G′(Pa), no greater than 10⁵ G′(Pa), or even no greater than 10⁴ G′(Pa) at 20 degrees Celsius as measured according to The Modulus Test.

In further embodiments, the composition can have a modulus of no greater than 10⁶ G′(Pa) at a temperature of not greater than 20 degrees Celsius, not greater than 10 degrees Celsius, not greater than 0 degrees Celsius, not greater than −10 degrees Celsius, not greater than −20 degrees Celsius, not greater than −30 degrees Celsius, or even not greater than −50 degrees Celsius as measured according to The Modulus Test.

In further embodiments, the composition can have a modulus of no greater than 10⁶ G′(Pa) across an entire temperature range of −25 degrees Celsius to 125 degrees Celsius, −15 degrees Celsius to 100 degrees Celsius, 0 degrees Celsius to 100 degrees Celsius, or even 15 degrees Celsius to 100 degrees Celsius.

To determine the initial tack of an adhesive composition, the adhesive composition can be formed into an adhesive tape using a standardized tape arrangement. Particularly, the test method disclosed herein can allow the use of the adhesive tape with the standardized tape arrangement to evaluate the initial tack of the adhesive composition. Accordingly, the initial tack can be prepared beforehand and not influenced by an additional layer or specialty substrate, and the initial tack of just the adhesive composition can be determined. Accordingly, it is to be understood that when the phrase “initial tack” and/or “initial tack test” refers to a property of the adhesive composition, a PET substrate and the modulus test disclosed herein can be used for measurement and evaluation. As used herein, a sample is said to have initial tack at a particular temperature if the sample has a modulus of less than about 3×10⁶ Pa at that particular temperature.

Accordingly, embodiments of the present disclosure can exhibit initial tack at a temperature of 25 degrees Celsius, 22 degrees Celsius, 20 degrees Celsius, 15 degrees Celsius, 10 degrees Celsius, 5 degrees Celsius, 0 degrees Celsius, −5 degrees Celsius, −10 degrees Celsius, −15 degrees Celsius, −20 degrees Celsius, −25 degrees Celsius, −30 degrees Celsius, −35 degrees Celsius, −40 degrees Celsius, or even −45 degrees Celsius.

Another way to quantify initial tack is experimental measurement. To perform the experimental initial tack test, a test temperature is selected and the sample is adhered to a steel plate and then placed horizontally into a chamber able to control temperatures to the desired testing temperature. The sample and steel plate are held at the testing temperature for 1 hour, and then a second steel plate is adhered to the free side of the sample. The first steel plate is then lifted vertically. If the second steel plate does not decouple from the first steel plate, the sample is considered to have passed the initial tack experimental measurement test at that temperature.

Accordingly, embodiments of the present disclosure can exhibit initial tack as determined by experimental measurement at an application temperature of 25 degrees Celsius, 22 degrees Celsius, 20 degrees Celsius, 15 degrees Celsius, 10 degrees Celsius, 5 degrees Celsius, 0 degrees Celsius, −5 degrees Celsius, −10 degrees Celsius, −15 degrees Celsius, −20 degrees Celsius, −25 degrees Celsius, −30 degrees Celsius, −35 degrees Celsius, −40 degrees Celsius, or even −45 degrees Celsius.

A particular advantage of the present disclosure is the ability of the adhesive composition to exhibit initial tack at low application temperatures. State of the art structural adhesive articles fail to exhibit an initial tack below about 30 degrees Celsius. It is to be understood that the adhesive composition can exhibit initial tack at other temperatures other than the specific temperature provided above, and in certain embodiments, can exhibit initial tack at temperatures ranging from at least −45 degrees Celsius to over 150 degrees Celsius.

Another parameter that describes an advantageous characteristic of the embodiments of the novel composition described herein is its improved shelf life. The shelf life can be measured by the Shelf Life Test. The shelf life of the adhesive composition can be determined by forming an adhesive tape with the adhesive composition and using a standardized tape arrangement of the adhesive composition disposed on a PET substrate. In particular, the test method below allows testing of the shelf life of the composition by forming a tape having a standardized setup such that the shelf life of the adhesive compositions can be prepared and not influenced by additional layers or specialty tape substrates. Accordingly, it is to be understood that the phrase “shelf life” and/or “shelf life test” when referred to as a property of the adhesive composition is measured and tested according to the standardized tape arrangement provided below.

The procedure for the shelf life test is as follows: To count as having shelf life, two criteria must be met. The first is the time it takes for the adhesive to lose initial tack as defined above after storage at a specified time at room temperature.

The second is the time it takes for the overlap shear strength to reach 85% of its initial value after storage at room temperature. The Shelf Life measurement used being the shorter of the two times.

A particular advantage of embodiments of the present disclosure is significantly improved shelf life of the composition. In fact, the current inventors surprisingly discovered compositions which could have significantly improved shelf life without sacrificing other qualities, such as overlap shear strength, pressure sensitive performance, displacement, and/or others.

In certain embodiments, the composition can have a shelf-life of at least 4 months, at least 5 months, at least 6 months, at least 7 months, at least 8 months, at least 9 months, at least 10 months, at least 11 months, or even at least 12 months as measured according to the Shelf Life Test.

Another parameter that describes an advantageous characteristic of embodiments of the novel composition described herein is a high overlap shear strength after curing. Overlap shear strength can be measured by the Lap Shear Test as outlined below using a standardized PET substrate such that a comparative overlap shear strength analysis of varying adhesive compositions can be obtained without influence of different substrate or composite structures.

The overlap shear strength and displacement of the tape being tested is determined by adhering a 20 mm by 20 mm strip (0.5 mm thick) of the tape between overlapping ends of steel panels (available from Advanced Coatings Technology; Hillsdale, Mich.) measuring 25 mm by 75 mm, such that the free ends of the panels extend in opposite directions. The composite is pressed together with 15 PSI pressure for 5 seconds. Then the composite is then hung in an oven with a target weight and cured. The sample is then cooled to room temperature and the displacement of the tape can be measured below steel panel from original place. Following, the sample is tested for overlap shear strength by extending the free ends of the panel in the jaws of an INSTRON Tensile Tester (model number 4501, available from Instron Corp., of Canton, Mass.) and separating the jaws at a rate of 300 mm/min. The overlap shear strength value of the cured tape, thus obtained, is recorded in MegaPascals (MPa).

In certain embodiments, the composition can have an overlap shear strength of at least 6 MPa, at least 7 MPa, at least 8 MPa, at least 9 MPa, at least 10 MPa, at least 11 MPa, at least 12 MPa, or even at least 13 MPa as measured according to the Lap Shear Test.

In certain embodiments, the adhesive composition can have an advantageous cure temperature. When the adhesive composition is being used, the adhesive composition is applied and cured. In particular embodiments, the adhesive composition can have a cure temperature of no greater than 165 degrees Celsius, no greater than 160 degrees Celsius, or even no greater than 155 degrees Celsius. In further embodiments, the adhesive composition can have a cure temperature of at least 120 degrees Celsius, at least 125 degrees Celsius, or even at least 130 degrees Celsius. Moreover, the adhesive composition can have a cure temperature in a range of any of the minimums and maximums provided above, such as in a range of from 120 degrees Celsius to 165 degrees Celsius, or even 125 degrees Celsius to 155 degrees Celsius. In very particular embodiments, the adhesive composition can have a cure temperature of about 150 degrees Celsius.

In certain embodiments, the adhesive composition can have an advantageous cure time. For example, in particular embodiments, the adhesive composition can have a cure time of no greater than 40 minutes, no greater than 35 minutes, or even no greater than 30 minutes. In further embodiments, the adhesive composition can have a cure time of at least 5 minutes, at least 10 minutes, or even at least 15 minutes. Moreover, the adhesive composition can have a cure time in a range of any of the minimums and maximums provided above, such as in a range of from 5 minutes to 40 minutes, 10 minutes to 35 minutes, or even 15 minutes to 30 minutes.

In further embodiments, the adhesive composition can have an advantageous combination of the cure temperature to cure time. For example, a particular advantage of the present disclosure is to quickly cure the adhesive composition at a relatively low temperature. As is understood in the art, in general, as the cure temperature increases, the cure time decreases. Accordingly, the adhesive composition can have a combination of the cure temperatures and cure times provided above. For example, the adhesive composition can have a cure temperature in a range of from 120 degrees Celsius to 160 degrees Celsius and a cure time in a range of from 10 minutes to 30 minutes.

In certain embodiments, the adhesive composition can have a desirable ratio of the cure temperature to the cure time. As used herein, the ratio of the cure temperature to the cure time is defined by dividing the cure temperature measured in degrees Celsius by the cure time measure in minutes. For example, if an adhesive composition has a cure temperature of 150 degrees Celsius and a cure time of 15 minutes, the ratio of the cure temperature to the cure time would be 10 degrees Celsius/minute. As yet another example, if the adhesive composition has a cure temperature of 120 degrees Celsius and a cure time of 30 minutes, the ratio of the cure temperature to the cure time would be 4 degrees Celsius/minute. Accordingly, in particular embodiments, the adhesive composition can have a ratio of the cure temperature to cure time of at least 4 degrees Celsius/minute, at least 5 degrees Celsius/minute, or even at least 6 degrees Celsius/minute. In further embodiments, the adhesive composition can have a ratio of the cure temperature to cure time of no greater than 13 degrees Celsius/minute, no greater than 12 degrees Celsius/minute, or even no greater than 11 degrees Celsius/minute. Moreover, the adhesive composition can have a ratio of the cure temperature to cure time in a range of any of the minimums and maximums provided above, such as in a range of from 4 degrees Celsius/minute to 13 degrees Celsius/minute, 5 degrees Celsius/minute to 12 degrees Celsius/minute, or even 6 degrees Celsius/minute to 11 degrees Celsius/minute.

It is to be understood that the cure temperature and cure time of the adhesive composition are inherent characteristic of the adhesive composition that can be measured and compared. As used herein, the cure temperature is defined to be the temperature which can be applied to the adhesive composition and takes no greater than 40 minutes to cure. There are two ways discussed to determine when a sufficient amount of curing has occurred to be considered “cured” according to the present disclosure. One is to characterize the curing by adhesive strength. Embodiments of the present disclosure are directed to adhesive compositions exhibiting a very high adhesive strength after curing. Thus, according to one method, the adhesive composition can be considered cured when the adhesive composition exhibits an adhesion strength of at least 6 MPa after initial application of the curing temperature. Similarly, the cure time is defined to be the time period beginning with the application of the curing temperature, and ending when the adhesive composition exhibits an adhesion strength of at least 6 Mpa.

It should be understood to those skilled in the art that this 6 MPa value is adhesive composition dependent. Other adhesive compositions could reach a time to cure whereby the adhesive strength would be less than 6 MPa due to the particular polymers employed to make up the adhesive composition. The definition of adhesive cure, as defined by an adhesive strength property (measured in units of force, MPa), is dependent on the adhesive composition.

Another way to determine when sufficient amount of curing has occurred to be considered “cured” according to the present disclosure is by measuring the modulus over time and determining the intersection of tangent lines in two distinct slope regions. For example, as is well understood in the art, the rate curing of an adhesive composition generally occurs rapidly in the beginning and significantly slows towards the end of the curing process and often requiring a long period of time to be technically considered a full cure. Accordingly, two distinct slope regions generally exist in a graph of the modulus over time during application of the cure temperature. The intersecting region of lines tangent to these distinct slope regions defines the curing time.

In further embodiments, and as discussed herein, embodiments of the novel composition can include a synergistic combination of the parameters/characteristics described above. For example, the composition can exhibit combinations of an advantageous overlap shear strength, an advantageous shelf-life, an advantageous modulus, and even all of the recited characteristics. Without wishing to be bound by theory, it is believed that these synergistic combination of parameters have never before been able to be achieved.

### Examples

Three samples were prepared and tested in comparison to commercially structural bonding tapes available from 3M tape.

Samples A, B, and C were prepared by combining the components identified in Table 1 below.

TABLE 1
Formulation of Samples

| Component | Sample A | Sample B | Sample C |
|---|---|---|---|
| PSA | 45 wt. % | 60 wt. % | 0 wt. % |
| Heat Resistant Resin | 22.5 wt. % | 0 wt. % | 59 wt. % |
| First Crosslinkable | 28.4 wt. % | 37 wt. % | 37 wt. % |
| Component (diallyl | | | |
| orthophthalate) | | | |
| Second Crosslinkable | 0 wt. % | 1.2 wt. % | 0 wt. % |
| Component (Epoxy) | | | |
| Filler (silicone oxide) | 2 wt. % | 2 wt. % | 2 wt. % |
| Substrate | Glass, PET, | Glass, PET, steel, | Glass, PET, |
| Arrangement | steel, | aluminum | steel, |
| | aluminum | | aluminum |

Samples A-C and the comparative 3M commercial product were measured for Modulus. As discussed within this document, adhesive tapes made with the adhesive composition described herein desire to have a high conformability before curing. Accordingly, to obtain high conformability, the modulus before curing should be low, such as less than 3×10⁶ Pa at 1 Hz, under application conditions.

The modulus was tested using an ARES-G2 Rheometer available from TA in oscillatory shear mode, with a temperature ramp from −55 degrees Celsius to 150 degrees Celsius at 5 degrees Celsius per minute and at 1 Hz.

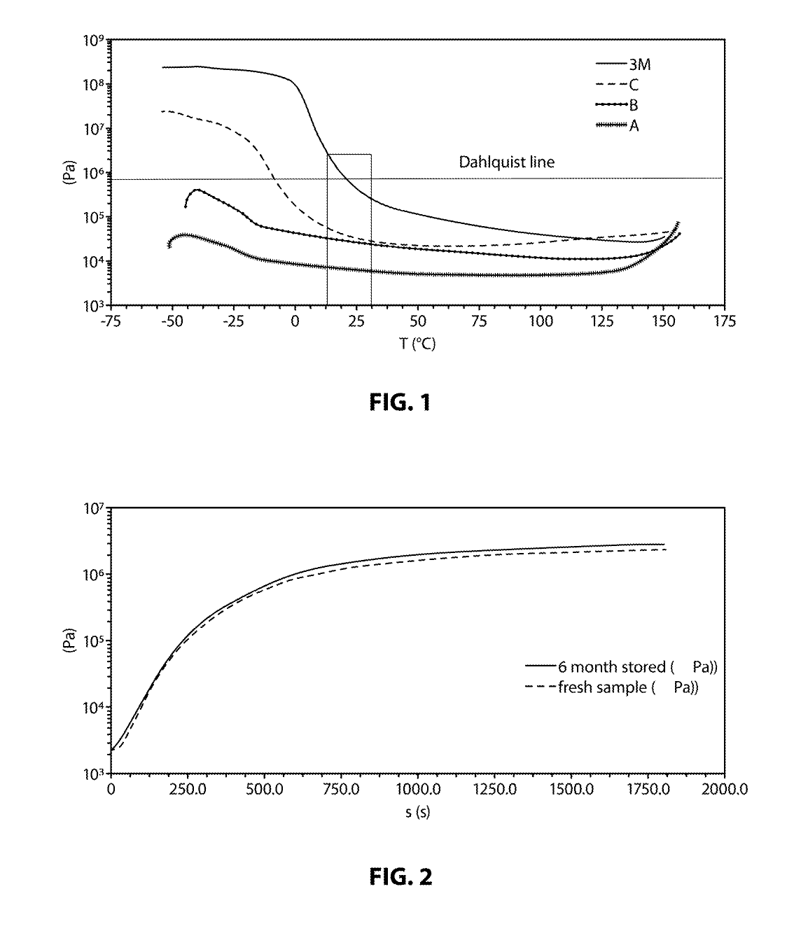

The results are reported in FIG. 1 which contains a graph of the modulus across the temperature range tested. As illustrated in FIG. 1, each of Samples A-C outperformed in the 3M comparative product, particularly at low temperatures, such as less than about 25 degrees Celsius.

As described above, the initial tack can be indirectly determined by the modulus of the sample at a given temperature. If the modulus is below 3×10⁶ Pa at 1 Hz at the specified temperature, the sample is considered to have initial tack as determined by modulus analysis. Referring to FIG. 1 which illustrates the modulus of various samples in comparison to the comparative modulus, it is seen that samples A and B have initial tack across a much wider temperature range, and particularly at lower temperatures, such as less than about 25 degrees Celsius.

Samples A-C and the comparative 3M sample were then tested for initial tack by experimental measurement at −15 degrees Celsius, 0 degrees Celsius, and 15 degrees Celsius to illustrate the effect the modulus has on the ability for the adhesive article exhibit a suitable initial tack. To measure the initial tack, the sample is adhered to a steel plate and then placed horizontally into a chamber able to control temperatures to the desired testing temperature. The sample and steel plate are held at the testing temperature for 1 hour, and then a second steel plate is adhered to the free side of the sample. The first steel plate is then lifted vertically. If the second steel plate does not decouple from the first steel plate, the sample is considered to have passed the initial tack test.

TABLE 2
Initial Tack Test Results

| | A | B | C | 3M |
|---|---|---|---|---|
| 15 Degrees Celsius | Pass | Pass | Pass | Pass |
| 0 Degrees Celsius | Pass | Pass | Pass | Fail |
| −15 Degrees Celsius | Pass | Pass | Fail | Fail |

The results indicate that Samples A, B, and C show improved initial tack at lower temperatures, which is in agreement with the initial test by modulus as outlined in Example 2a.

Sample B was tested for its shelf life according to the rheology test method. To test for shelf life under a rheology test, the sample is initially tested for Modulus during curing, and tested again for Modulus after aging at room temperature and humidity for 6 months. The sample is said to have shelf life at the particular time frame and at the particular application temperature if the aged modulus closely correlates to the initial modulus. The results of the Rheology Shelf Life Tests are illustrated in FIG. 2. As can be seen, the aged sample's modulus closely correlates to the initial modulus, and thus sample B has a shelf life of at least 6 months.

Each of samples A-C and the comparative 3M samples were tested for shelf life according to an application test method. To test for shelf life under the application test method, a sample is adhered to a steel plate and the placed horizontally into an oven at 75 degrees Celsius. After dwelling at 75 degrees Celsius for 8 hours a second steel plate is adhered to the sample, thereby sandwiching the sample between the two steel plates. The results of the Application Shelf Life Test is illustrated in Table 3.

TABLE 3
Application Shelf Life Test Results

| Storage | | | | 3M |
|---|---|---|---|---|
| temp | Sample A | Sample B | Sample C | (comparative) |
| 75 C. | <20 hours | >30 hours | >30 hours | >20, but <30 |
| | | | | hours |
| Room temp | <3 months | >12 months | >12 months | <6 month |

As can be seen, samples B and C have a longer shelf life than the 3M comparative product as measured according to the Application Shelf Life Test.

Sample D was prepared and tested in comparison to a Comparative Sample E including a commercial structural bonding tape 9214 available from 3M. Sample D was prepared by combining the components identified in Table 4 below and forming into a tape containing a single layer of the adhesive.

TABLE 4

| Component | Sample L | |
|---|---|---|
| PSA | 0 | wt. % |
| Heat Resistant Resin | 59 | wt. % |
| First Crosslinkable | 12/12/12 | wt. % |
| Component (diallyl | | |
| orthophthalate/diallyl | | |
| terephthalate/SR504 | | |
| from Sartomer) | | |
| Second Crosslinkable | 0 | wt. % |
| Component (Epoxy) | | |
| Filler (silicone oxide) | 2 | wt. % |

| | |
|---|---|
| Substrate | Glass, steel, |
| Arrangement | aluminum |

An assembly was created using each Sample D and E wherein an aluminum block was bonded to a steel plate using the given sample adhesive. The assembly was cured at 145° C. for 25 minutes and then aged using Aging Condition 1 and then Aging Condition 2. Aging Condition 1 includes 10 cycles of (a) 12 hours (h) at 40° C., 95 RH; (b) 1 h at 40° C., 95 RH→−30° C.; (c) 4 h at −30° C.; (d) 2 h at −30° C.→70° C., 95 RH; (e) 4 h at 70° C., 95 RH; and (f) 1 h at 70° C., 95 RH→40° C., 95 RH. Aging Condition 2 includes 1 cycle of (a) 168 h at 70° C., 100 RH; and (b) 16 h at −20° C.

To test the parallel torque, a torque spanner was coupled to the block and rotated at 1 rad/s. The torque value was measured when the adhesive broke. The adhesion area used was 625 mm². The results are reported as Nm. The following results provided in Table 5 were obtained.

TABLE 5
Parallel Torque

| | Aging Condition 1 | Aging Condition 2 | |
|---|---|---|---|
| | Parallel Torque | Parallel Torque | |
| Sample | (Nm) | (Nm) | |
| Sample D | >100 Nm | >100 | Nm |
| Comparative Sample E | >100 Nm | 85 ± 5 | Nm |

Based on the results of Table 6, the Sample D performed at least as well as Comparative Sample E after Aging Condition 1 and significantly outperformed Comparative Sample E after Aging Condition 2.

Many different aspects and embodiments are possible. Some of those aspects and embodiments are described below. After reading this specification, skilled artisans will appreciate that those aspects and embodiments are only illustrative and do not limit the scope of the present invention. Embodiments may be in accordance with any one or more of the items as listed below.

Item 1. An adhesive composition comprising:
a. an acrylic based pressure sensitive adhesive resin; and
b. a first crosslinkable component, wherein the first crosslinkable component is present in the composition in a significant amount.

Item 2. An adhesive composition comprising:
a. an acrylic based pressure sensitive adhesive resin; and
b. a first crosslinkable component, wherein the first crosslinkable is adapted to form a crosslinked inter penetrated network (IPN) upon curing.

Item 3. An adhesive composition comprising:
a. an acrylic based pressure sensitive adhesive resin; and
b. a first crosslinkable component;
c. wherein the first crosslinkable component does not form a separate phase from the acrylic resin.

Item 4. An adhesive composition comprising:
a. an acrylic based pressure sensitive adhesive resin; and
b. a first crosslinkable component comprising diallyl orthophalate in an amount of at least about 5 wt %, based on the total dry weight of the adhesive composition.

Item 5. An adhesive composition comprising:
a. a pressure sensitive adhesive resin;
b. a first crosslinkable component; and
c. a second crosslinkable component,
   wherein the first crosslinkable component has a greater weight percentage in the composition than the second crosslinkable component, based on the total weight of the composition,
   wherein the first crosslinkable component is different than the second crosslinkable component, and
   wherein the second crosslinkable component has a lower cure temperature than the first crosslinkable component.

Item 6. An adhesive composition comprising:
a. a pressure sensitive adhesive resin; and
b. a crosslinkable component;
   wherein the composition has at least two of the following characteristics:
      an overlap shear strength of greater than 8 MPa as measured according to the Lap Shear Test after aging of at least 4 months;
      a pressure sensitive performance of not greater than 10⁶ G′(Pa) at a temperature of not greater than 20 degrees Celsius; and/or
      a shelf life of at least 6 months as measured according to the Shelf Life modulus or experimental test;

Item 7. The adhesive composition of any one of the preceding items, wherein the first crosslinkable component has at least one allyl group.

Item 8. The adhesive composition of any one of the preceding items, wherein the first crosslinkable component has at least two allyl groups.

Item 9. The composition of any one of the preceding items, wherein the first crosslinkable component comprises a phthalate (phthalate esters, esters of phtalic acid, structure).

Item 10. The adhesive composition of any one of the preceding items, wherein the first crosslinkable component comprises diallyl orthophthalate.

Item 11. The adhesive composition of any one of the preceding items, wherein the first crosslinkable component is non-volatile.

Item 12. The adhesive composition of any one of the preceding items, wherein the first crosslinkable component is non-volatile and wherein the first crosslinkable component provides a reduction in viscosity to the acrylic resin.

Item 13. The adhesive composition of any one of the preceding items, wherein the first crosslinkable component has a general formula 1 or 2:

CH2=CHCOOROOCCH═CH2 (1)

CH2=CHCH2OCOROCOCH2CH═CH2 (2)
wherein, R represents an aliphatic compound having from 1 to 12 carbon atoms, an ether group, an alicyclic hydrocarbon, or an aromatic hydrocarbon (having ortho-, iso-, or tere-structure).

Item 14. The adhesive composition of any one of the preceding items, wherein the first crosslinkable component is present in the composition in an amount of at least about 3 wt. %, at least about 4 wt. %, at least about 5 wt. %, at least about 6 wt. %, at least about 7 wt. %, at least about 8 wt. %, at least about 9 wt. %, at least about 10 wt. %, at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 21 wt. %, at least about 22 wt. %, at least about 23 wt. %, at least about 24 wt. %, or even at least about 25 wt. %, based on the total weight of the composition.

Item 15. The adhesive composition of any one of the preceding items, wherein the first crosslinkable component is present in the composition in an amount of no greater than about 75 wt. %, no greater than about 70 wt. %, no greater than about 65 wt. %, no greater than about 60 wt. %, no greater than about 55 wt. %, no greater than about 50 wt. %, no greater than about 45 wt. %, no greater than about 40 wt. %, or even no greater than about 35 wt. %, based on the total weight of the composition.

Item 16. The adhesive composition of any one of the preceding items, wherein the first crosslinkable component does not form a separate phase from the acrylic resin.

Item 17. The adhesive composition of any one of the preceding items, wherein the first crosslinkable component is in the same phase as the acrylic resin.

Item 18. The adhesive composition of any one of the preceding items, wherein the composition further comprises a second crosslinkable component, wherein the first crosslinkable component is different than the second crosslinkable component.

Item 19. The adhesive composition according to any one of the preceding items, wherein the second crosslinkable component comprises a structural adhesive resin.

Item 20. The adhesive composition of any one of the preceding items, wherein the second crosslinkable component is present in the composition in an amount of at least about 0.1 wt. %, at least about 0.2 wt. %, at least about 0.5 wt. %, at least about 0.8 wt. %, or at least about 1 wt. %, based on the total weight of the composition.

Item 21. The adhesive composition of any one of the preceding items, wherein the second crosslinkable component is present in the composition in an amount of not greater than about 10 wt. %, not greater than about 8 wt. %, not greater than about 7 wt. %, not greater than about 5 wt. %, or not greater than about 3%, or not greater than about 1%, based on the total weight of the composition.

Item 22. The adhesive composition of any one of the preceding items, wherein the second crosslinkable component is present in the composition in a weight percentage amount of less than the first crosslinkable component.

Item 23. The adhesive composition of any one of the preceding items, wherein the second crosslinkable component comprises an epoxy, phenolic aldehyde, urea formaldehyde, alkyd resin, urethane, or combinations thereof.

Item 24. The adhesive composition of any one of the preceding items, wherein the second crosslinkable component begins crosslinking at a lower temperature than the first crosslinkable component.

Item 25. The adhesive composition of any one of the preceding items, wherein the acrylic resin comprises a PSA resin.

Item 26. The adhesive composition of any one of the preceding items, wherein the acrylic resin comprises an acrylate resin.

Item 27. The adhesive composition of any one of the preceding items, wherein the acrylic resin comprises poly(meth)acrylate, ethylacrylate, ethyl methacrylate, or combinations thereof.

Item 28. The adhesive composition of any one of the preceding items, wherein the acrylic resin comprises an emulsion based acrylic PSA.

Item 29. The adhesive composition of any one of the preceding items, wherein the composition comprises a solvent based acrylic PSA.

Item 30. The adhesive composition of any one of the preceding items, wherein the acrylic resin is present in the composition in an amount of at least 1 wt. %, at least 5 wt. %, at least 10 wt. %, at least 20 wt. %, at least 30 wt. %, at least 40 wt. %, at least 50 wt. %, or even at least 60 wt. %, based on the total dry weight of the composition.

Item 31. The adhesive composition of any one of the preceding items, wherein the acrylic resin is present in the composition in an amount of no greater than 90 wt. %, no greater than 85 wt. %, or even no greater than 80 wt. % based on the total dry weight of the composition.

Item 32. The adhesive composition of any one of the preceding items, wherein the composition further comprises a filler.

Item 33. The adhesive composition of any one of the preceding items, wherein the filler comprises silicon dioxide, or combinations thereof.

Item 34. The adhesive composition of any one of the preceding items, wherein the filler is present in the composition in an amount of at least 1 wt. %, based on the total weight of the composition.

Item 35. The adhesive composition of any one of the preceding items, wherein the filler is present in the composition in an amount of no greater than 10 wt. % or even no greater than 5 wt. %, based on the total weight of the composition.

Item 36. The adhesive composition of any one of the preceding items, wherein the composition further comprises a heat resistant resin.

Item 37. The adhesive composition of any one of the preceding items, wherein the heat resistant resin comprises acrylate, polyurethane (PU), a diallyl orthophthalate prepolymer, or combinations thereof.

Item 38. The adhesive composition of any one of the preceding items, wherein the heat resistant resin is present in the composition in an amount of at least about 1 wt. %, at least about 5 wt. %, or even at least about 10 wt. % based on the total dry weight of the composition.

Item 39. The adhesive composition of any one of the preceding items, wherein the heat resistant resin is present in the composition in an amount of no greater than 90 wt. %, no greater than 80 wt. %, or even no greater than 70 wt. % based on the total dry weight of the composition.

Item 40. The adhesive composition of any one of the preceding items, wherein the heat resistant resin is an elastomer.

Item 41. The adhesive composition of any one of the preceding items, wherein the heat resistant resin has a glass transition temperature of no greater than 100 degrees Celsius, no greater than 85 degrees Celsius, or even no greater than 70 degrees Celsius.

Item 42. The adhesive composition of any one of the preceding items, wherein the heat resistant resin has a glass transition temperature of at least 0 degrees Celsius, at least 5 degrees Celsius, or even at least 10 degrees Celsius.

Item 43. The adhesive composition of any one of the preceding items, wherein the heat resistant resin has a glass transition temperature in a range of from 10 degrees Celsius to 70 degrees Celsius.

Item 44. The adhesive composition of any one of the preceding items, wherein the composition has a modulus of no greater than 10⁶ G′(Pa) at a temperature of 15 degrees Celsius, 10 degrees Celsius, 5 degrees Celsius, 0 degrees Celsius, −5 degrees Celsius, −10 degrees Celsius or even −50 degrees Celsius as measured according to The Modulus Test.

Item 45. The adhesive composition of any one of the preceding items, wherein the composition has a modulus of less than 10⁶ G′(Pa), less than 10⁵ G′(Pa), or even less than 10⁴ G′(Pa) at 20 degrees Celsius as measured according to The Modulus Test.

Item 46. The adhesive composition of any one of the preceding items, wherein the composition has a modulus of less than 10⁶ G′(Pa) at a temperature of not greater than 20 degrees Celsius, not greater than 10 degrees Celsius, not greater than 0 degrees Celsius, not greater than −10 degrees Celsius, not greater than −20 degrees Celsius, not greater than −30 degrees Celsius, or even not greater than −50 degrees Celsius as measured according to The Modulus Test.

Item 47. The adhesive composition of any one of the preceding items, wherein the composition has a modulus of less than 10⁶ G′(Pa) across an entire temperature range of −25 degrees Celsius to 125 degrees Celsius.

Item 48. The adhesive composition of any one of the preceding items, wherein the composition has a shelf-life of at least 4 months, at least 5 months, at least 6 months, at least 7 months, at least 8 months, at least 9 months, at least 10 months, at least 11 months, or even at least 12 months as measured according to The Shelf Life Test.

Item 49. The adhesive composition of any one of the preceding items, wherein the composition has an overlap shear strength of at least 6 MPa, at least 7 MPa, at least 8 MPa, at least 9 MPa, at least 10 MPa, at least 11 MPa, at least 12 MPa, or even at least 13 MPa as measured according to The Lap Shear Test.

Item 50. The adhesive composition of any one of the preceding items, wherein the composition has at least two of the following characteristic:
a. an overlap shear strength of at least 8 MPa as measured according to The Lap Shear Test;
b. a shelf-life of at least 4 months as measured by The Shelf Life Test; and
c. a modulus, G′ (Pa), of less than 10⁶ G′(Pa) at 10 degrees Celsius.

Item 51. The adhesive composition of any one of the preceding items, wherein the composition has the following characteristic:
a. an overlap shear strength of at least 8 MPa as measured according to The Lap Shear Test;
b. a shelf-life of at least 4 months as measured by The Shelf Life Test; and
c. a modulus, G′ (Pa), of less than 10⁶ G′(Pa) at 10 degrees Celsius.

Item 52. The adhesive composition of any one of the preceding items, wherein the composition is a curable composition.

Item 53. The adhesive composition of any one of the preceding items, wherein composition has initial tack as determined by modulus at a temperature of 25 degrees Celsius, 22 degrees Celsius, 20 degrees Celsius, 15 degrees Celsius, 10 degrees Celsius, 5 degrees Celsius, 0 degrees Celsius, −5 degrees Celsius, −10 degrees Celsius, −15 degrees Celsius, −20 degrees Celsius, −25 degrees Celsius, −30 degrees Celsius, −35 degrees Celsius, −40 degrees Celsius, or even −45 degrees Celsius.

Item 54. The adhesive composition of any one of the preceding items, wherein composition has initial tack as determined by experimental measurement at a temperature of 25 degrees Celsius, 22 degrees Celsius, 20 degrees Celsius, 15 degrees Celsius, 10 degrees Celsius, 5 degrees Celsius, 0 degrees Celsius, −5 degrees Celsius, −10 degrees Celsius, −15 degrees Celsius, −20 degrees Celsius, −25 degrees Celsius, −30 degrees Celsius, −35 degrees Celsius, −40 degrees Celsius, or even −45 degrees Celsius.

Item 55. The adhesive composition of any one of the preceding items, wherein the adhesive composition has a cure temperature of no greater than 165 degrees Celsius, no greater than 160 degrees Celsius, or even no greater than 155 degrees Celsius.

Item 56. The adhesive composition of any one of the preceding items, wherein the adhesive composition has a cure temperature of at least 120 degrees Celsius, at least 125 degrees Celsius, or even at least 130 degrees Celsius.

Item 57. The adhesive composition of any one of the preceding items, wherein the adhesive composition has a cure temperature in a range of from 120 degrees Celsius to 165 degrees Celsius, or even 125 degrees Celsius to 155 degrees Celsius

Item 58. The adhesive composition of any one of the preceding items, wherein the adhesive composition has a cure temperature of about 150 degrees Celsius.

Item 59. The adhesive composition of any one of the preceding items, wherein the adhesive composition has a cure time of no greater than 40 minutes, no greater than 35 minutes, or even no greater than 30 minutes.

Item 60. The adhesive composition of any one of the preceding items, wherein the adhesive composition has a cure time of at least 5 minutes, at least 10 minutes, or even at least 15 minutes.

Item 61. The adhesive composition of any one of the preceding items, wherein the adhesive composition has a cure time in a range of from 5 minutes to 40 minutes, 10 minutes to 35 minutes, or even 15 minutes to 30 minutes.

Item 62. The adhesive composition of any one of the preceding items, wherein the adhesive composition has a cure temperature in a range of from 120 degrees Celsius to 160 degrees Celsius and a cure time in a range of from 10 minutes to 30 minutes.

Item 63. The adhesive composition of any one of the preceding items, wherein the adhesive composition has a ratio of the cure temperature to cure time of at least 4 degrees Celsius/minute, at least 5 degrees Celsius/minute, or even at least 6 degrees Celsius/minute.

Item 64. The adhesive composition of any one of the preceding items, wherein the adhesive composition has a ratio of the cure temperature to cure time of no greater than 13 degrees Celsius/minute, no greater than 12 degrees Celsius/minute, or even no greater than 11 degrees Celsius/minute.

Item 65. The adhesive composition of any one of the preceding items, wherein the adhesive composition has a ratio of the cure temperature to cure time in a range of from 4 degrees Celsius/minute to 13 degrees Celsius/minute, 5 degrees Celsius/minute to 12 degrees Celsius/minute, or even 6 degrees Celsius/minute to 11 degrees Celsius/minute.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

What is claimed is:

1. An adhesive composition comprising:
a. a pressure sensitive adhesive resin;
b. a first crosslinkable component; and
c. a second crosslinkable component,
wherein the first crosslinkable component has a greater weight percentage in the composition than the second crosslinkable component, based on the total weight of the composition,
wherein the first crosslinkable component is different than the second crosslinkable component, and
wherein the second crosslinkable component has a lower cure temperature than the first crosslinkable component.

2. The adhesive composition of claim 1, wherein the first crosslinkable component has at least one allyl group.

3. The adhesive composition of claim 1, wherein the first crosslinkable component has at least two allyl groups.

4. The composition of claim 1, wherein the first crosslinkable component comprises a phthalate.

5. The adhesive composition of claim 1, wherein the first crosslinkable component comprises diallyl orthophthalate.

6. The adhesive composition of claim 1, wherein the first crosslinkable component is non-volatile.

7. The adhesive composition of claim 1, wherein the first crosslinkable component is non-volatile and wherein the first crosslinkable component provides a reduction in viscosity to the acrylic resin.

8. The adhesive composition of claim 1, wherein the first crosslinkable component has a general formula 1 or 2:
CH2=CHCOOROOCCH═CH2 (1)
CH2=CHCH2OCOROCOCH2CH═CH2 (2)
wherein, R represents an aliphatic compound having from 1 to 12 carbon atoms, an ether group, an alicyclic hydrocarbon, or an aromatic hydrocarbon (having ortho-, iso-, or tere-structure).

9. The adhesive composition of claim 1, wherein the first crosslinkable component is present in the composition in an amount of at least about 3 wt. %.

10. The adhesive composition of claim 1, wherein the second crosslinkable component comprises a structural adhesive resin.

11. The adhesive composition of claim 1, wherein the second crosslinkable component comprises an epoxy, phenolic aldehyde, urea formaldehyde, alkyd resin, urethane, or combinations thereof.

12. The adhesive composition of claim 1, wherein the second crosslinkable component begins crosslinking at a lower temperature than the first crosslinkable component.

13. The adhesive composition of claim 1, wherein the composition further comprises a filler.

14. The adhesive composition of claim 1, wherein the filler comprises silicon dioxide.

15. The adhesive composition of claim 1, wherein the composition further comprises a heat resistant resin.

16. The adhesive composition of claim 1, wherein the heat resistant resin comprises acrylate, polyurethane (PU), a diallyl orthophthalate prepolymer, or combinations thereof.

17. The adhesive composition of claim 1, wherein the heat resistant resin has a glass transition temperature of no greater than 100 degrees Celsius.

18. The adhesive composition of claim 1, wherein the composition has at least two of the following characteristic:
a. an overlap shear strength of at least 8 MPa as measured according to The Lap Shear Test;
b. a shelf-life of at least 4 months as measured by The Shelf Life Test; and
c. a modulus, G′ (Pa), of less than 10⁶ G′(Pa) at 10 degrees Celsius.

19. An adhesive composition comprising:
a. an acrylic based pressure sensitive adhesive resin; and
b. a first crosslinkable component comprising diallyl orthophthalate in an amount of at least about 5 wt %, based on the total dry weight of the adhesive composition.

20. An adhesive composition comprising:
a. a pressure sensitive adhesive resin; and
b. a crosslinkable component;
wherein the composition has at least two of the following characteristics:
an overlap shear strength of greater than 8 MPa as measured according to the Lap Shear Test after aging of at least 4 months;
a pressure sensitive performance of not greater than 10⁶ G′ (Pa) at a temperature of not greater than 20 degrees Celsius; and
a shelf life of at least 6 months as measured according to the Shelf Life modulus or experimental test.
